(19) United States
(12) Patent Application Publication
(10) Pub. No.: US 2006/0137191 A1
(43) Pub. Date: Jun. 29, 2006

(54) Hot knife roof cutting tool

(76) Inventor: Ray Hightower, Long Beach, CA (US)

Correspondence Address: FULWIDER PATTON LEE & UTECHT, LLP, 200 OCEANGATE, SUITE 1550, LONG BEACH, CA, 90802, US

(21) Appl. No.: 11/022,725

(22) Filed: Dec. 27, 2004

(51) Int. Cl. B26B 3/00

(52) U.S. Cl. 30/169

(57) ABSTRACT

A roofing tool including a linear body formed with a central handle having a mount projecting in one direction to mount a blade and a counterbalance projecting in the opposite direction.

### FIELD OF THE INVENTION

The present invention relates to a tool used in cutting and sealing roofing strips in place.

### BACKGROUND OF THE INVENTION

### Description of the Prior Art

Roofers, in applying water and weather resistant strips of roofing to a flat or even pitched roofs are faced with a considerable challenge to efficiently and effectively apply the strips, cut them to length and width and seal overlapping marginal edges together such that during even the most vigorous storms moisture and weather does not permeate the overlapping seal and the underlying roof resulting in damage to the interior of the building.

In recognition of these needs, much attention has been given to the design and construction of various styles and configuration of cutting knives used to cut the roofing strips to a desired shape. Various knives have been proposed with removable or permanently attached blades and various different tools have been utilized to tamp or press the roofing strips in place.

Busy workman attending to the application of roofing strips to a large roof often move over considerable area and space during a work period thus removing them some distance from their toolboxes and tool kits. Thus, the workman is motivated to carry the various tools utilized during the roofing process from his or her tool belt or pouch thus making them readily available at the point were the work is carried out.

Also, the efficiency of motion during a large roofing project is particularly important as any lost time is compounded over the life of the project.

During a roofing project, strips of roofing are typically unrolled from rolls to lay down side by side over the roof. Marginal edges may be overlapped to, when sealed, provide for a continuous sheet of weather resistant roofing. Typically the marginal edges are adhered together by hot tar or a hot torch process which, when cooled, is intended to provide a secure, continuous water resistant skin. In cutting the strips to shape many cuts are required along the marginal edges to mate together and to fit around various obstacles such as chimneys breather pipes and the like. Ergonomics dictate that the tool used in the cutting process have a favorable balance so as to minimize fatigue in repetitive use and to enhance comfort in manipulation of the tool. It is also important to the integrity in the sealing process that the joint where the marginal edges overlap the upper layer be pressed firmly towards the lower layer throughout the entire length of the sealing joint while the sealant remains hot and fluid. Various efforts have been made to perfect this pressing process, including merely stepping on the seal in effort to press the seal firmly together or, grasping a tool and rubbing it along the sealing joint. As it will be apparent, merely stepping on selected areas along the overlap is unsatisfactory as various areas thereof will not be subjected to a pressing force thus resulting in a low integrity or incomplete along the joint. Other efforts involving the use of a tool to rub along the surface has the shortcoming that the worker must carry the pressing tool with him or her to have it available for the pressing step and such tools often become misplaced and are not readily available when the time comes to press the joint seal. Of equal importance is the fact that the requirement for the workman to carry and utilize such an extra tool detracts from efficiency, both in the time required to locate the tool and the time to take it exchange a roofing knife for the pressing tool to undertake the pressing step for one joint and to there after exchange back to the knife for cutting the next strip to length or width or to tailor shape around various obstacles or roof edges.

### SUMMARY OF THE INVENTION

The tool of the present invention is characterized by an elongated rigid body having a central handle, a blade on one end and a counterbalance on the opposite end formed with a pressing edge. The counterbalance can easily be grasped to remove the tool from the users tool pouch and the handle grasped to maneuver the blade of the knife into position to draw the blade through the strip to, as the counterbalance affords an enhanced moment of inertia resisting the force moment applied to the tool by the resistance against the blade as it cuts through the strip to trim it to length. As the cutting stroke is completed, the counter balance may be utilized to facilitate spinning of the tool in the user's hand to present the pressing edge toward the strip to press it down. In practice the pressing edge may extend perpendicular to the axial direction of the tool or might angle laterally in one direction or the other to provide a sloped surface.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a perspective view of a counter balanced roof cutting tool embodying the present invention;

FIG. 2 is a top plan view thereof;

FIG. 3 is a front view thereof;

FIG. 4 is a longitudinal sectional view taken along the line 4-4 of FIG. 2;

FIG. 5 is a partial perspective view summary to FIG. 1 but showing the blade retracted;

FIG. 6 is an exploded perspective view of the tool shown in FIG. 1 showing the blade being removed;

FIG. 7 is a top view, in a large scale, of the apparatus shown in FIG. 2 depicted pressing roofing strips together;

FIG. 8 is a longitudinal sectional view taken along the line 8-8 of FIG. 7;

FIG. 9 is a perspective view similar to FIG. 1 but showing a cover on the tool;

FIG. 10 is a plan view of the tool shown in FIG. 1;

FIG. 11 is a partial top plan view of the tool shown in FIG. 10 but with the blade retracted;

FIG. 12 is a partial bottom plan view of the tool shown in FIG. 11; and

FIG. 13 is a transverse sectional view in a large scale taken along the lines 13-13 of FIG. 11

### DETAILED DESCRIPTION OF THE PREFERRED EMBODIMENT

In one embodiment, the counter balanced roofing tool of the present invention includes an elongated rigid metallic body 11 formed centrally with a handle 13 and configured on its forward extremity with a knife blade mount 15 on its opposite extremity with a counter balance that might form a press 17.

The body is generally rectangular in transverse cross section and is formed in its top plan view shown in FIG. 2 with lateral sides 21 and 23 which angle rearwardly and laterally outwardly in wedge shape to from the knife mount 15 to the rear edge 25 which, in the exemplary embodiment is dispose in a plane perpendicular to the longitudinal axis of the tool.

In the construction business, it is often important that the roofing process take place in a rapid manner. This is important both from the context of profitably and is often necessitated by the fact that it is important to roof the structure in a rapid manner so as to provide a weather proof interior in the event in climate weather. The workman often work fully exposed to heat or cold during the entire working shift and, when working rapidly, unrolling heavy sheets of roofing and moving into place and trimming the edges thereof can experience exhaustion and sometimes cramping of the muscles, often testing there overall endurance which may, in the end, lead to a shortened work day or diminished efficiency. Thus, there exists a need for a roofing cutting tool which is compact, does not subject the workman to excess physical exertion and which can be conveniently used induces effectively allowing for convenient grasping of the tool on a repetitive basis for retrieval from the tool pouch and use there of to draw a knife through the thickness and width of a roofing strip.

The tool body 11 is typically constructed of metal, such as aluminum or steel which may be treated in such a manner as to resist abrasion and wear and which provides some degree of weight to afford a comfortable and positive feel in use.

To promote good ergonomics, the tool is preferably not of excessive length but of appreciable weight and for convenience of storage and usage, is preferably a linear construction. In the embodiment selected for disclosure, the overall length of the body is 10½ inches and the forward extremity is 1.3 inches wide, about ¼ inch thick, with the laterally opposite sides defining tapered side edges 21 and 23 fanning outwardly in the rearward direction to a maximum width at the pressing edge 25 of 1½ inches to provide a relatively heavy counterbalance thus providing a thin light knife mount 15 which can be easily and readily manipulated about and fitted into tight quarters to make the necessary cut and a bulkier, heavy counter balance 17 with a rubbing edge 25 which has a robust width so as to make good contact with the roofing material being pressed together.

The blade mount 15 is formed on at least one side with an elongated rectangular, outwardly opening, open-ended groove 31 (FIG. 5) for sliding receipt of an elongated blade, generally designated 33.

The blade 33 is double ended with each side configured with a pair of laterally outwardly facing V-notches 35 and 37 (FIG. 5) formed with sharp edges. The distal end 39 may also be formed with sharp edge. The blade 33 is formed centrally with an elongated slot 41 and a bore 45 is formed in the mount 15 centrally within the slot 41 for receipt of a thumbscrew 49 which may hold the blade adjustably in position.

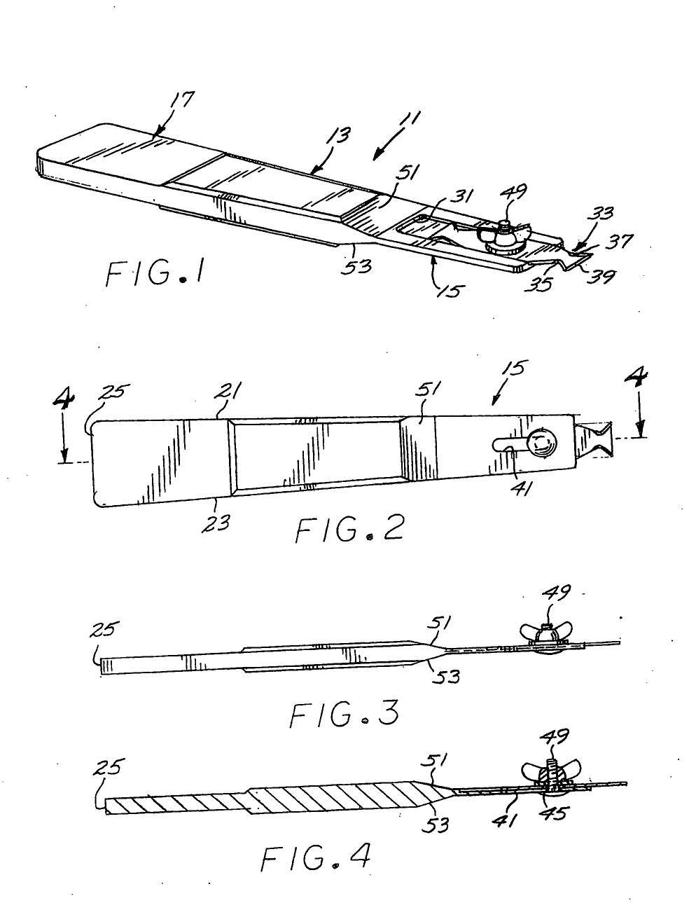

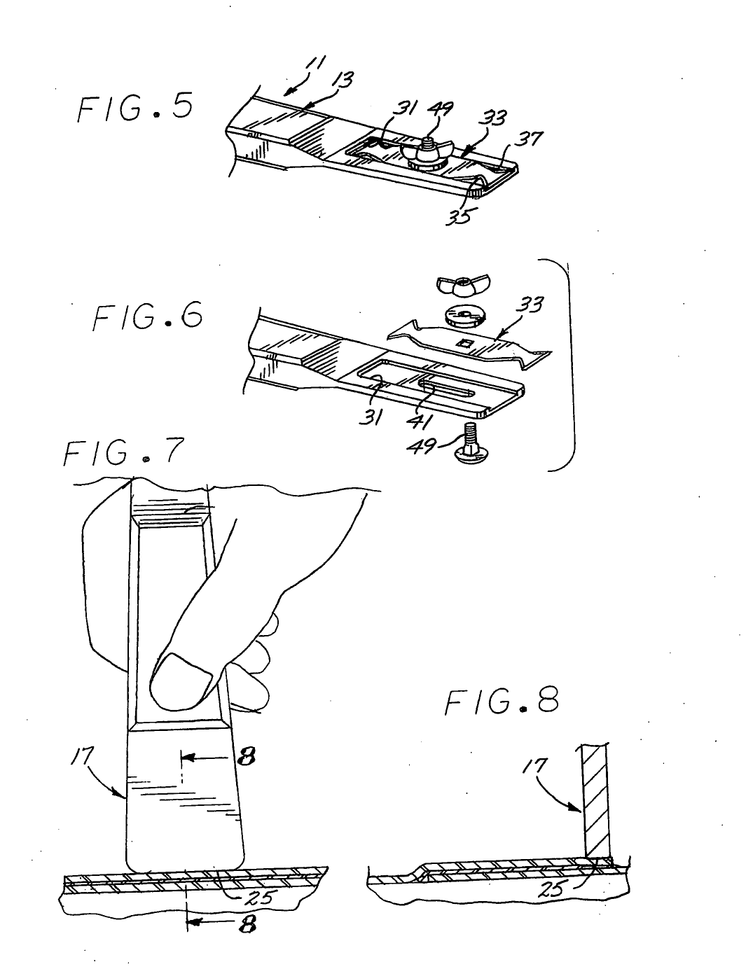

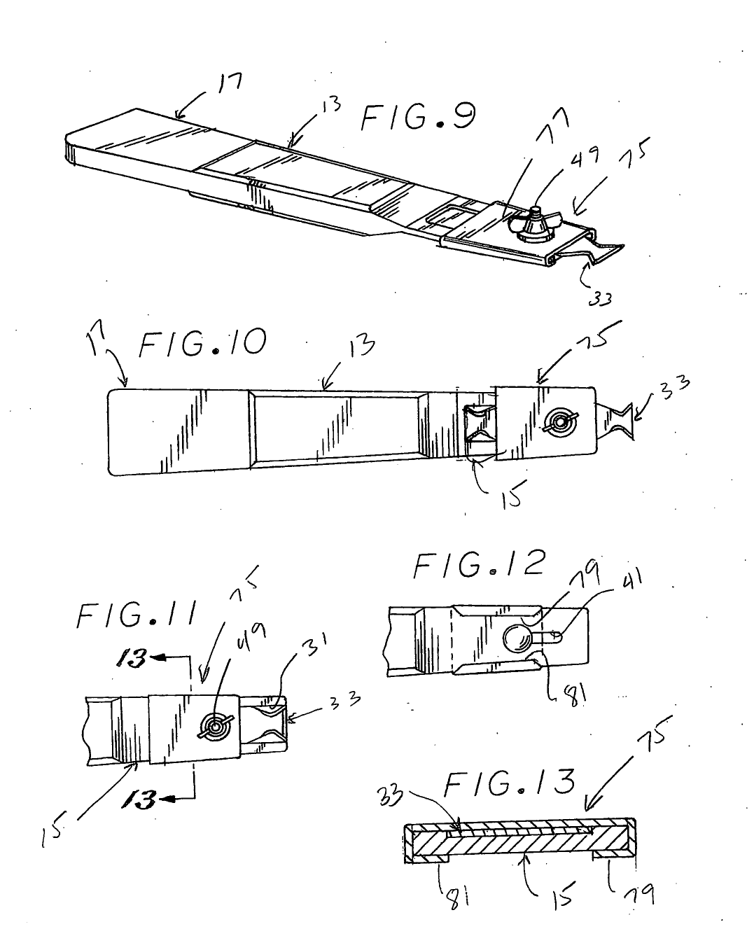

At the rear extremity of the blade mount 15 the top and bottom sides of the body angle laterally outwardly away from one another along respective bevels 51 and 53 (FIG. 1) to a width of ¾ of an inch to thus provide a relatively comfortable cross section for the handle 13. At the opposite end of the handle, the top and bottom sides of the body angle inwardly and distally along respective bevels 52 and 54 (FIG. 3). The corners 56 at the opposite sides of the handle are configured with 0.12 inch by 45° chamfers to thus form respective breaks to provide more comfort for the user. At the rear extremity of the handle 13 the top and bottom surfaces angle inwardly along chamfers, also 0.12 by 45° to form the press 17 with a thickness of about 0.43 inches.

The distally expanding width of the counterbalance 17 provides for a majority of its weight to be positioned spaced rearwardly from the mid point of the tool body and preferably sized to provide a weight about three times that of the blade mount 15 to thus afford a moment of inertia to resist rotation of such tool about an axis laterally through its mid point.

As an optional component, I include a channel shaped cover, generally designated 75 with my roofing tool. This cover may take many different forms, may be constructed of metal, plastics, leather or any other desired material. The cover may take numerous different forms such as a leather sheath, plastic housing with a belt clip or any other form which will be apparent to those skilled in the art with the understanding of the preferred embodiment disclosed herein. In the exemplary embodiment, I show a channel shaped metal cover formed with a top wall 77 covering the top side and which is turned down at its opposite edges and then turned back on itself to form retainer lips 79 and 81 on the bottom side for cooperating in grasping the opposite sides of the tool. In the exemplary embodiment, the sides of the cover 75 are tapered forwardly and inwardly toward one another to compliment the shape of the tool itself.

In operation, it will be appreciated that a workman can purchase the tool of the present invention and insert the blade 33 slidably in the groove 31 and adjust such blade to the retracted position in FIG. 5 for storage or the extended position shown in FIGS. 1 and 2 when it is to be utilized for a roofing project.

When the strips of roofing have been unrolled and it is desirable to cut a strip to length or to cut a pattern in an edge to accommodate irregular shapes, the workman may grasp the counterbalance 17 and slide his or her hand along the tool to the handle 15. The wing nut of the bolt 49 may be loosened to free the blade 33 so it can be extended from the position shown in FIG. 11 to the position shown in FIG. 12 and the wing nut tightened on the adjustment bolt 49 to secure it in the position shown in FIG. 12 so the user can then apply the sharp edges of such blade to the roofing strip to make a cut to separate the strip along a selected contour. As will be appreciated by those skilled in the art, when the blade is drawn laterally in one direction along the roofing strip forcing the cutting edge through that strip, the reactive force on the blade will apply a moment to the tool tending to rotate in one direction in the user's hand. This moment will be resisted by the moment of inertia of the counterbalance to a degree dictated by the overall weight thereof multiplied by the distance from the longitudinal center of the handle to the center of gravity of such counterbalance. As noted, the fact the sides of such counterbalance fan laterally outwardly serves to shift the center of gravity rearwardly from where it would be in the case of a uniform width counterbalance thus creating a favorable balance for the tool when grasped by the central handle. In the preferred embodiment the expanded rear extremity of the tool serves to shift the center of gravity about 10% of the overall length of the tool rearward from when it would otherwise be for the particular configuration shown. As will be appreciated, the inertia resistance reduces the force the user must apply to the handle to resist the torque applied thereto during the cutting action. While this reduction in the force may be required rather insignificant for each cutting stroke, the cumulative effect thereof over a ten-hour workday is significant and can lead to a reduction in fatigue and tendonitis in the wrist, not unlike the affliction known as carpal tunnel as associated with other repetitive tasks such as typing.

After adjacent strips have been cut to length and shape, attention will be given to sealing of the overlapping edges of the adjacent strips. Typically a bonding material such as tar is applied between the overlapping margins of adjacent strips or a hot torch is applied to the overlap to generate molten tar at the interface. To press the margins together, the tool is rotated in the users hand to face the counter balance toward the roofing. It is of advantage that the counterbalance provides a somewhat equalizing counter balance to the blade mount so the user can easily spin the tool in his or her hand, similar to the spinning of a baton. With the relatively balanced weight of the tool, this maneuver can easily be achieved one handed by even a relatively unskilled workman thus efficiently converting the tool from a knife to a press. The spun tool may then be conveniently gripped in reverse by the handle, to press the pressing edge against the roofing as shown FIGS. 7 and 8 to secure a firm and reliable contact. As will be appreciated by those working in the field, in most applications the workman may merely grip the hand grasp to press the tool toward the roofing. In some instances, a bump or rise in the roofing may be encountered thus requiring grater pressing force. This may be achieved by the workman sliding his or her hand upwardly slightly from the grip position shown in FIG. 7 to engage the upwardly facing transition bevels 51 and 53 between the grip and the mount to thus gain more purchase power to facilitate downward pressing. Once the pressing action for that overlap is completed, the workman may again spin the tool in one hand readying the knife blade for the next cut.

This task may then be repeated for as many cuts and trimmings as are necessary to complete the roofing job. Once the cutting is complete, the wing nut on the bolt 49 may again be loosened to free the blade 33 so it may be retracted to the retracted position shown in FIG. 11 with the distal edge thereof aligned with or retracted from the end of the tool itself. The tool may then be stored in any desired location, such as the user's toolbox or the like.

From the foregoing it will be apparent that the combination cutting and pressing tool provides an ergonomic tool which allows for user comfort during the cutting process having a rearward projection from the handle for convenient grasping and which counter balances the cutting process and provides for a counter weight to affords effortless one handed rotation of the tool for utilization of the press while maintaining the blade readily available for the next cutting process.

I claim:

1. A counter balanced linear roofing tool comprising:
a elongated rigid body formed centrally with a hand grip and projecting axially longitudinally there from in one direction to define on one extremity a reduced in cross section knife blade mount, the body also projecting longitudinally in the opposite direction from the hand grip to define, an enlarged in cross section elongated counterbalance, axially aligned therewith and terminating at its distal end with a transverse distally facing edge; and
a knife blade removable mounted to the blade mount whereby a craftsman may grasp the counterbalance with one hand and slide the hand to the hand grip to manipulate the tool to direct the blade in one direction downwardly toward a strip of roofing to be drawn in one direction for cutting thereof while the counterbalance provides a moment of inertia resisting rotation of the tool in the users hand.

2. A roofing tool as set forth in claim 1 that includes:
mounting means for removably mounting the blade.

3. The tool of claim 1 wherein:
the body is substantially 10½ inches long.

4. The tool of claim 1 wherein:
the edge is flat.

5. The tool of claim 1 wherein:
the edge is substantially 1½ inches wide.

6. The tool of claim 1 wherein:
the handle is substantially is 4½ inches long.

7. The tool of claim 1 wherein:
the maximum width of the body is 1½ inches.

8. The tool of claim 1 wherein:
the body projects rearwardly from the blade mount and includes opposite edges which taper laterally outwardly from one another.

9. The tool of claim 1 wherein:
the mount includes an elongated open ended slot; and
the blade is slidably received in the slot and includes laterally outwardly facing sharpened V-notches on the opposite thereof.

10. A combination linear roofing cutting and pressing tool comprising:
an elongated body 1½ inches long and formed its forward extremity with an elongated forwardly opening blade slot;
the body being formed intermediately with rectangular and transverse cross-section handle, the handle having a thickness of about ¾ of an inch and a width of about 1.3 inches; and
the body projecting rearwardly from the handle and being formed with an elongated counterbalance defining a presser terminating at it rearward extremity and a laterally extending pressing edge having a width of 1 1/2 inches and a thickness of about 0.4 inches.

11. The tool of claim 10 wherein:
the handle is rectangular in transverse cross section and includes 45° chamfers on the corners thereof.

12. The tool of claim 10 wherein:
the presser is formed on the opposite lateral edges of the pressing edge with 45° chamfers.

13. The tool of claim 10 wherein:
the body transitions down in transverse cross section from the handle to the mount to form a purchase surface facing longitudinally away from the counterbalance to be engaged by the user's hand when pressing the edge toward roofing.

14. The tool of claim 10 wherein:
the weight of the counterbalance is substantially three times that of the blade mount.

15. A roofing tool comprising:
an elongated rigid body formed centrally with a rectangular and cross-section handle having a blade mount projecting forwardly from one extremity thereof and a counterbalance projecting rearwardly from the opposite extremity thereof;
the counter balance being formed on its distal end with a laterally projecting pressing edge; and
a blade removably mounted to the forward extremity of the mount and including on its opposite sides laterally facing cutting edges.

16. The roofing tool of claim 15 includes:
a cover covering at least one side of the blade mount.

17. A roofing tool of claim 15 wherein:
the rigid body is formed with the mount having a rectangular transverse cross-section; and
a rigid channel shaped cover formed with a body covering one side of the mount and formed so the opposite sides thereof extend over the opposite edges of the mount and turn back to form retaining lips.

18. The roofing tool of claim 15 wherein:
the rigid body is formed with opposite edges that taper inwardly and toward one another from the pressing edge; and
a cover constructed to cover the mount and embrace the opposite edges thereof, such cover being formed of the opposite edges tapering forwardly and inwardly to compliment the taper of the tool.

19. The roofing tool of claim 15 wherein:
the mount is formed with a longitudinally extending open-ended groove, such mount being further formed with an elongated through slot formed centrally in the groove;
an elongated blade received slidably in the groove and formed with an opening there through aligned with the slot;
a bolt received in the slot and opening including a nut for tightening of the blade in position; and
a channel shaped cover formed to be disposed in covering relationship over the blade and formed at its opposite extremities to cover the opposite edges of the mount and then being turned inwardly to form retaining lips, the cover further being formed with a bore for receipt of the mounting bolt.
